(19) United States
(12) Patent Application Publication
(10) Pub. No.: US 2026/0249300 A1
(43) Pub. Date: Aug. 27, 2026

(54) DEVICE TO IMPROVE SORTING STREAM ALIGNMENT ON CELL SORTER

(71) Applicant: THE JACKSON LABORATORY, Bar Harbor, ME (US)

(72) Inventors: William SCHOTT, Farmington, CT (US); Jarek TRAPSZO, Farmington, CT (US)

(21) Appl. No.: 18/871,217

(22) PCT Filed: Jun. 2, 2023
(86) PCT No.: PCT/US2023/024328

§ 371 Date: Dec. 3, 2024

Related U.S. Application Data
(60) Provisional application No. 63/348,791, filed on Jun. 3, 2022.

(51) Int. Cl. B01L 9/06; G01N 15/10; G01N 15/149

(52) U.S. Cl. CPC B01L 9/06; G01N 15/149; B01L 2200/025; G01N 2015/1006

(57) ABSTRACT

Improved mounts and other elements are provided to facilitate alignment of multi-tube sample holders with multi-stream cell- and/or other particle-sorting apparatus. These elements are able to adjust the location of a tube holder relative to the particle sorting apparatus in several degrees of freedom, allowing the alignment of the tubes to the sorter to be easily and accurately adjusted, thereby improving sorted sample capture and reducing technician effort and. time. Additionally, these elements can include a laser or laser mount to facilitate visualization of the streams relative to the tubes, thereby facilitating adjustment of the relative location of the tubes. Such a laser mount can be adjustable to control the location and orientation of a laser mounted thereto relative to the tubes and/or particle-bearing droplet streams, facilitating visualization of the streams.

### CROSS-REFERENCE TO RELATED APPLICATION

This application claims priority to U.S. Provisional Patent Application No. 63/348,791, filed on Jun. 3, 2022, the contents of which are hereby incorporated by reference in their entirety.

### FIELD OF THE INVENTION

This invention relates to devices for performing cell sorting including flow cytometry. The invention specifically relates to an improvement in sorting stream alignment and optionally illumination in cell-containing fluid media for sorting based on cell/particle size, fluorescence, and/or other parameters. Provided here are fabricated devices used as modifications of existing flow cytometric or other cell sorting devices.

### BACKGROUND

Unless otherwise indicated herein, the description in this section is not prior art to the claims in this application and is not admitted to be prior art by inclusion in this section.

Flow cytometry is a method developed to permit separation of particles, specifically cells or cell-containing particles, from a mixture or suspension based on physical, optical, fluorescent, and/or other parameters. Using flow cytometry, cells can be separated by size and/or volume, or can be detectably labeled, for example using fluorescent labels (in this embodiment termed fluorescence-activated cell sorting, or FACS), to distinguish cells to be sorted into different populations. In some embodiments, cells are sorted by charging droplets containing the cells, which are then deflected by charged plates to diverge from a center stream to a selected one of two or more collection tubes. By varying the charge on the drops, 6 or more different collection tubes can be used to separate the cells into respective six or more samples. The cells are sorted at a high rate such that the series of sorted drops appear as a solid stream to the unaided human eye. Such populations can then be isolated after flow cytometric segregation.

A variety of flow cytometry or other cell-sorting instrumentation is available, for example devices such as the BD FACSymphony S6 cell sorter. There is a continuing need in the flow cytometric and/or cell-sorting arts for improvements in the features and capabilities of flow cytometers, cell sorters, and related techniques and methods.

### SUMMARY

This disclosure provides improvements in the form of devices for use with flow cytometers or other cell sorting apparatus. In some embodiments the disclosure set forth herein provides a custom tube holder mount capable of limited translation and rotation to align multiple (e.g., 6-way) sorting streams with tubes (e.g., using set screws to set and/or lock the angle and depth of the mount with the cell sorter instrument), and an optional adjustable side mounted laser to illuminate streams just above the collection tubes. In some embodiments of the disclosure, a mount is provided for adapting a plate to a cell sorter along with a camera mount (e.g., for a borescope-type camera) to allow the sorting of streams of cell-containing particles into the wells of the plate to be observed and adjusted.

In an example embodiment, a mount is provided as a replacement for a stock mount, configured to be secured to the bottom of a sorting block of a cell sorter. The mount is configured to have affixed thereto various chilled tube holders (e.g., for various tube sizes). The mounts provided herein exhibit increased adjustment ability and optionally add illumination of sorting streams near the ends of their target tubes using a laser. Such a mount permits adjustments of the rotation about the cell-sorted streams as well as translation in a forward-back direction by, e.g., turning horizontal set screws incorporated into the mount. Optionally, four vertical set screws facilitate adjustment of the fit of the mount on the sort block of the cell sorter instrument. The optional laser holder is positioned on the side of the mount and can be moved vertically and horizontally, inter alia, on a track and swept horizontally on an angle in order improve illumination of the streams by the laser.

In a first embodiment, an adjustable adapter is provided that includes: (i) a first mount that is configured to secure the adjustable adapter to a sort block of a particle sorter, wherein the particle sorter emits, from the sort block, a plurality of streams of particle-bearing fluid in respective different directions; and (ii) a second mount that is formed to secure a tube holder to the adjustable adapter, wherein the adjustable adapter is adjustable to (i) control an orientation of the second mount relative to the sort block about a first axis that is substantially parallel to an overall direction of the plurality of streams when the first mount is secured to the sort block and the particle sorter is emitting the plurality of streams and (ii) control translation of the second mount relative to the sort block in a first direction that is substantially perpendicular to the first axis.

The adjustable adapter can further include two screws, wherein the two screws are disposed within respective threaded holes through the adjustable adapter such that, when the first mount is secured to the sort block, differential rotation of the two screws results in adjustment of the orientation of the second mount relative to the sort block about a first axis and in-common rotation of the two screws results in adjustment of the translation of the second mount relative to the sort block along the first direction. Respective ends of the two screws can be in contact with the particle sorter when the first mount is secured to the sort block. The adjustable adapter can further include a set screw, wherein an end of the set screw is in friction contact with the particle sorter when the first mount is secured to the sort block, thereby securing the first mount to the sort block, and wherein a magnitude of the friction contact of the set screw with the particle sorter is adjustable by rotating the set screw.

The adjustable adapter can further include a laser mount, wherein the laser mount is operable to direct a laser mounted thereto through the plurality of streams of particle-bearing fluid when the first mount is secured to the sort block. The laser mount can be adjustable to (i) control translation of a laser mounted thereto relative to the second mount along a second direction that is substantially parallel to the first direction, (ii) control translation of a laser mounted thereto relative to the second mount along a third direction that is substantially perpendicular to the second direction, and (iii) control an orientation of a laser mounted thereto relative to the second mount about a second axis that is substantially perpendicular to the third direction. This can include the adjustable adapter further including a laser set screw and a laser set nut, wherein the laser set screw is threaded into the laser set nut, and wherein the laser set screw is disposed within a slot in a laser mount arm that extends along the third direction such that tightening the laser set screw into the laser set nut secures the translation of a laser mounted to the laser mount along the third direction and secures the orientation of a laser mounted to the laser mount about the second axis and further such that loosening the laser set screw from the laser set nut permits adjustment of the translation of a laser mounted to the laser mount along the third direction and the orientation of a laser mounted to the laser mount about the second axis, and wherein the laser mount is rigidly coupled to one of the laser set screw or the laser set nut such that rotation of the one of the laser set screw or the laser set nut about the second axis results in the rotation of the laser mount about the second axis.

In a second embodiment, a system is provided that includes (i) a particle sorter configured to emit, from a sort block, a plurality of streams of particle-bearing fluid in respective different directions; and (ii) an adjustable adapter that includes a first mount that is formed to secure a tube holder to the adjustable adapter, wherein the adjustable adapter is adjustable to (i) control an orientation of the first mount relative to the sort block about a first axis that is substantially parallel to an overall direction of the plurality of streams when the particle sorter is emitting the plurality of streams and (ii) control translation of the first mount relative to the sort block in a first direction that is substantially perpendicular to the first axis.

The adjustable adapter of the system can further include: (i) a second mount that is formed to secure the adjustable adapter to the sort block; and (ii) two screws, wherein the two screws are disposed within respective threaded holes through the adjustable adapter such that, when the second mount is secured to the sort block, differential rotation of the two screws results in adjustment of the orientation of the first mount relative to the sort block about a first axis and in-common rotation of the two screws results in adjustment of the translation of the first mount relative to the sort block along the first direction. Respective ends of the two screws can be in contact with the particle sorter when the second mount is secured to the sort block. The adjustable adapter of the system can further include a set screw, wherein an end of the set screw is in friction contact with the particle sorter when the second mount is secured to the sort block, thereby securing the second mount to the sort block, and wherein a magnitude of the friction contact of the set screw with the particle sorter is adjustable by rotating the set screw.

The adjustable adapter of the system can further include a laser mount, wherein the laser mount is operable to direct a laser mounted thereto through the plurality of streams of particle-bearing fluid. The laser mount can be adjustable to (i) control translation of a laser mounted thereto relative to the first mount along a second direction that is substantially parallel to the first direction, (ii) control translation of a laser mounted thereto relative to the first mount along a third direction that is substantially perpendicular to the second direction, and (iii) control an orientation of a laser mounted thereto relative to the first mount about a second axis that is substantially perpendicular to the third direction. The adjustable adapter of such a system can further include a laser set screw and a laser set nut, wherein the laser set screw is threaded into the laser set nut, and wherein the laser set screw is disposed within a slot in a laser mount arm that extends along the third direction such that tightening the laser set screw into the laser set nut secures the translation of a laser mounted to the laser mount along the third direction and secures the orientation of a laser mounted to the laser mount about the second axis and further such that loosening the laser set screw from the laser set nut permits adjustment of the translation of a laser mounted to the laser mount along the third direction and the orientation of a laser mounted to the laser mount about the second axis, and wherein the laser mount is rigidly coupled to one of the laser set screw or the laser set nut such that rotation of the one of the laser set screw or the laser set nut about the second axis results in the rotation of the laser mount about the second axis.

These as well as other aspects, advantages, and alternatives will become apparent to those of ordinary skill in the art by reading the following detailed description, with reference, where appropriate, to the accompanying drawings.

### BRIEF DESCRIPTION OF THE DRAWINGS

FIG. 1 is a schematic showing elements of a cell sorting system, according to example embodiments.

FIG. 2 is a perspective view of an adapter mount, according to example embodiments.

FIG. 3 is a second perspective view of the adapter mount depicted in FIG. 2, according to example embodiments.

FIG. 4 is a top view of the adapter mount depicted in FIG. 2, according to example embodiments.

FIG. 5 is a side view of the adapter mount depicted in FIG. 2, according to example embodiments.

FIG. 6 is a front view of the adapter mount depicted in FIG. 2, according to example embodiments.

FIG. 7 is an image of an adapter mount, a tube holder, and other elements within a cell sorting system, according to example embodiments.

FIG. 8 is an image of an adapter mount, a tube holder, and other elements within a cell sorting system, according to example embodiments.

FIG. 9 is an image of an adapter mount, a tube holder, and other elements within a cell sorting system, according to example embodiments

FIG. 10 is a perspective view of an adapter mount, according to example embodiments.

FIG. 11 is an image of an adapter mount, a multi-well sample plate, and other elements within a cell sorting system, according to example embodiments.

### DETAILED DESCRIPTION

Example methods and systems and methods of use thereof are contemplated herein. Any example embodiment or feature described herein is not necessarily to be construed as preferred or advantageous over other embodiments or features. Further, the example embodiments described herein are not meant to be limiting. It will be readily understood that certain aspects of the disclosed systems and methods can be arranged and combined in a wide variety of different configurations, all of which are contemplated herein. In addition, the particular arrangements shown in the figures should not be viewed as limiting. It should be understood that other embodiments might include more or less of each element shown in a given figure. Additionally, some of the illustrated elements can be combined or omitted. Yet further, an example embodiment can include elements that are not illustrated in the figures.

Throughout this description, various directions, axes of rotation, or similar linear features or references are referred to as being “substantially parallel” or “substantially perpendicular.” One of skill in the art will appreciate that two linear features or references being “substantially” parallel (or perpendicular) means that those two linear features or references are exactly parallel (or perpendicular), or nearly so. So, two linear features or references being described herein as being “substantially parallel” means that an angle between the two linear features or references is less than a small threshold angular deviation, e.g., less than 15 degrees, or less than 5 degrees. Similarly, two linear features or references being described herein as being “substantially perpendicular” means that an angle between the two linear features or references differs from ninety degrees by less than a small threshold angular deviation, e.g., the angle is between 75 and 105 degrees, or between 85 and 95 degrees.

A variety of systems are available to identify cells or other particles within a sample and to sort the cells/particles into separate sample holders according to their type. This can be done to, e.g., isolate a desired sub-type of the particles from the sample, to divide a sample into a number of different sub-samples according to a varying degree of one or more measured properties (e.g., size, protein expression, cell-surface antigens), to generate a ‘purified’ homogeneous sample of a particle or cell from a heterogeneous sample, or to accomplish some other desired separation.

Such cell or particle separation from a sample can be accomplished in a variety of ways, e.g., by using a cell sorter to separate the sample into a plurality of individual droplets, each containing a respective cell/particle, and then directing the droplets, according to their cell/particle contents, into respective different sample containers (e.g., tubes). This can be accomplished in a variety of ways, and based on a variety of cell/particle properties measured in a variety of ways.

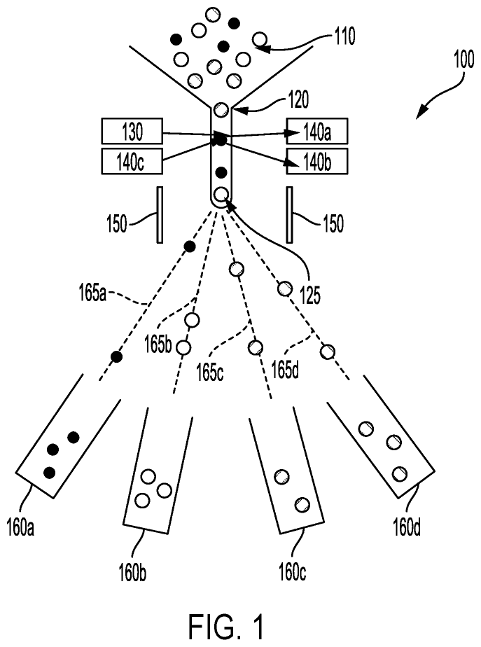

FIG. 1 illustrates aspects of a particle sorting system 100 for performing such particle identification/measurement and sorting. A source sample 110 includes a variety of different populations of particles, indicated by different shading. Each population of particles can be a different type of particle (e.g., a different type of immune or blood cells) and/or that vary continuously with respect to one or more properties (different populations corresponding to different ranges of size, opacity, protein content, geometry, and/or some other measurable particle property). The particles are introduced serially into a detection channel 120 such that each can be individually measured. This can include, as shown in FIG. 1, optical interrogation by using a light source 130 (e.g., a laser) to illuminate the individual particles in the channel 120 and to detect reflected, scattered, fluorescent or otherwise emitted light from the particles in response to the illumination (e.g., by a transmission light sensor 140a, a forward scatter light sensor 140b, a back-scatter light sensor 140c, and/or some other light sensor(s)).

Each particle is then discharged from the channel, via a tip 125 of the channel, in a respective droplet of carrier fluid. The droplets can then be directed, as part of respective streams of droplets 165a, 165b, 165c, 165d, to respective sample tubes 160a, 160b, 160c, 160d. This can be accomplished by, for example, applying a charge to the droplets (e.g., via an electron beam, by applying a voltage to a conductive element of the tip 125) and then directing the trajectory of the charged droplets by controlling an electric and/or magnetic field in the vicinity of the tip 125 and/or along the streams 165a-d (e.g., using charged plates 150 disposed on either side of the tip 125). The direction and/or velocity of the droplets can be controlled by adjusting an amount of charge applied to each droplet and/or controlling the magnitude, direction, or other properties of the applied electric or magnetic field. Accordingly, each droplet can be directed to the correct one of the sample tubes 160a-d that corresponds to the determined identity and/or property of the particle within the droplet.

Regardless of the method used to classify particles in a sample, to segregate the particles into droplets, and to manipulate the velocity of such droplets, a plurality of streams of droplets, each stream composed of droplets containing a respective different type or class of particle, can be emitted from a “sort block” of a particle sorting apparatus toward respective different sample containers (e.g., wells of a multi-sample plate or tubes in a tube holder). The “sort block” of such an apparatus is a rigid element of the apparatus that includes one or more apertures from which the droplet streams are emitted. Sample tube holders, plate holders, or other mechanisms can be mounted to the sort block to align such sample-containing elements with the sort block, thereby facilitating collection of the droplets of each stream into respective sample containers.

Modern particle sorting systems can generate six or more droplet streams directed toward respective six or more sample containers. Such systems can be operated to adjust the separation of the streams and their absolute angle of emission from the sort block (e.g., by adjusting an amount of charge applied to droplets containing particles of each separated population and/or by adjusting a magnitude of an applied electric field). However, it is difficult to see the streams of droplets as they travel through the air, and so it is difficult to know how to adjust the angles of the streams such that they enter the appropriate sample holders. Additionally, the possible adjustments to the streams are limited with respect to, e.g., total angle, difference in angle between streams, or the angle of the plane containing all of the streams, and so it can be difficult or impossible to align the streams with a set of sample containers (e.g., set of tubes in a tube holder) in practice. For example, if the particle sorter is limited to adjusting the angle of the droplet streams relative to each other in a plane whose location and angle are fixed, then the particle sorter cannot be operated to adapt if the plane of the sample holders does not intersect sufficiently with the plane of the droplet streams. These difficulties can be magnified by changes to the apparatus and/or elements mounted thereto (e.g., tube holders) that can affect the trajectory of the streams and/or their relationship with the target sample containers.

The embodiments described herein address these shortcomings by providing adjustable adapters that are operable to rigidly couple multiple sample holders (e.g., multiple sample tubes held in a tube holder) to the sort block or other element of a particle sorting system. Such adapters are adjustable to control location and orientation of the sample holders relative to the droplet streams emitted from the sort block in order to allow the plane of the sample holders to be aligned with the plane of the droplet streams emitted from the sort block in an intuitive manner. Additionally, such adjustable adapters can include lasers or other light emitters to facilitate the visualization of the droplet streams by illuminating them.

Such adjustable adapters can be part of the particle sorting system or can be removable (e.g., removably mountable to the sort block). Such adjustable adapters can be configured to hold a number (e.g., 2, 4, 6, or more) of sample containers (e.g., sample tubes). Additionally or alternatively, such adjustable adapters can include a mount for mounting a variety of different sample holders thereto (e.g., a mount to allow different refrigerated multiple sample tube holders to be magnetically mounted thereto), allowing the sample holders to be easily swapped without requiring the alignment of the droplet streams to the sample holders to be re-adjusted.

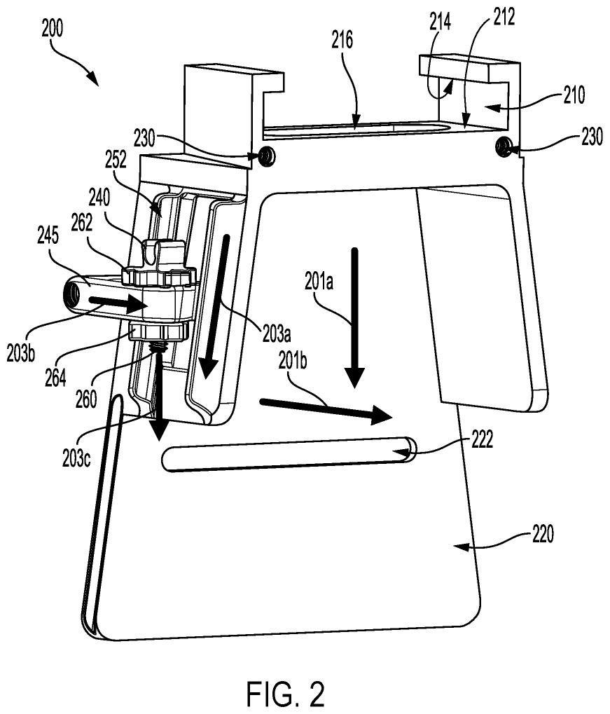

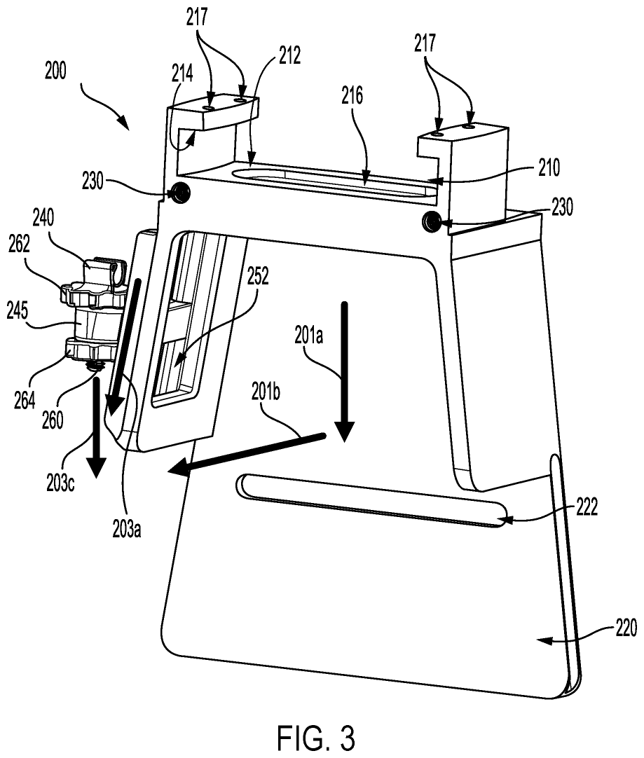

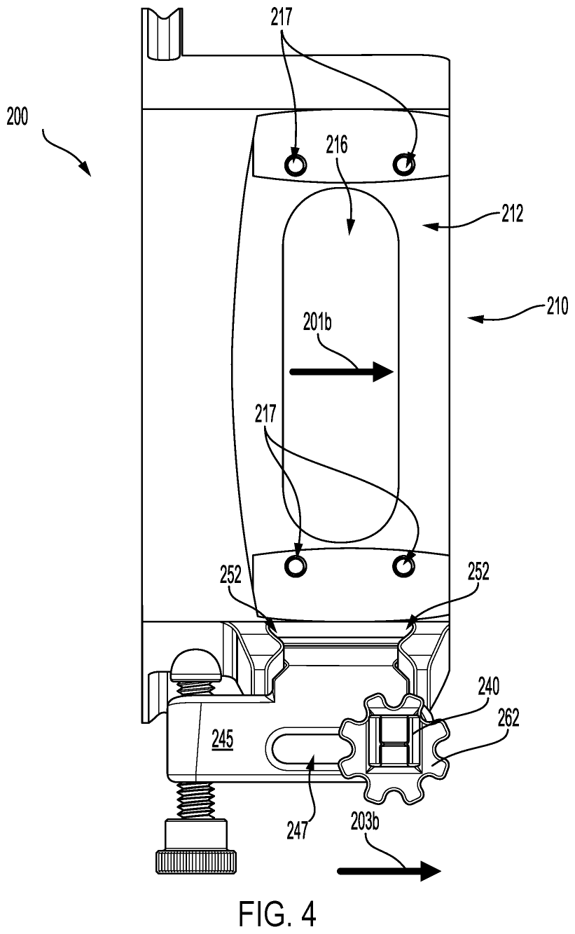

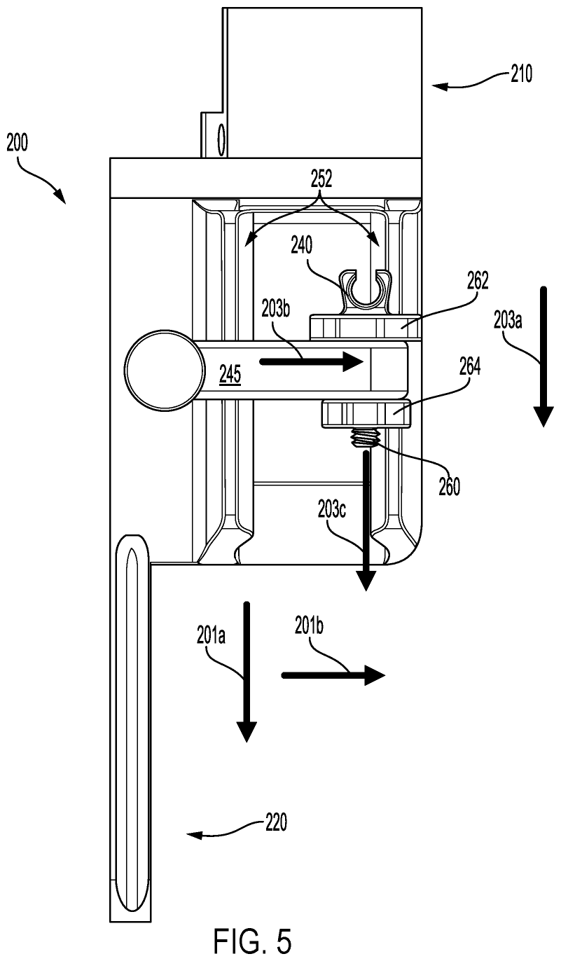

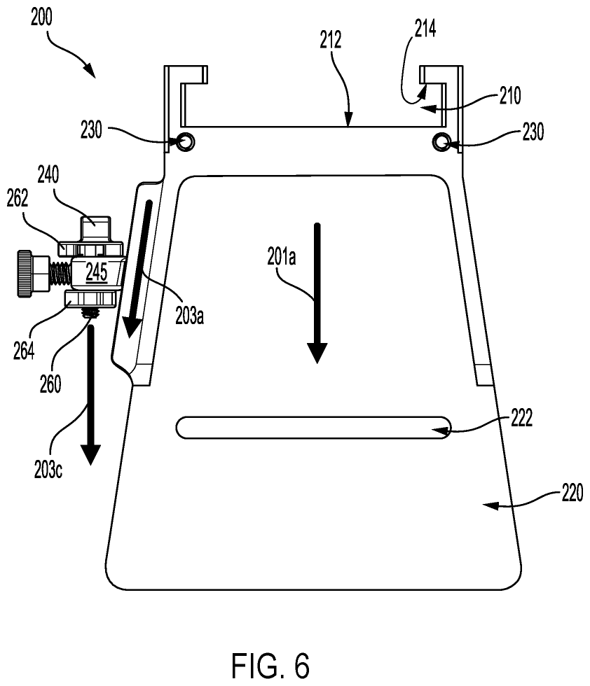

FIGS. 2, 3, 4, 5, and 6 are upper left perspective, upper right perspective, top, side, and front views, respectively, of an example of an adjustable adapter 200 as described herein. The adjustable adapter 200 includes a first mount 220 that is formed to secure a tube holder (not shown) to the adjustable adapter 200. Such a tube holder can be configured to hold two or more (e.g., six) sample tubes, and can include channels or other features formed therein to refrigerate or otherwise control the temperature of the sample tubes. The adjustable adapter 200 can include slots (e.g., slot 222), holes, pegs, or other features to facilitate alignment of the tube holder to the first mount 220. The first mount 220 can also include screws, threaded holes, clamps, magnetic elements (e.g., magnets, magnetic or magnetizable materials) to facilitate removably mounting the tube bolder to the first mount 220. For example, the adjustable adapter 200 can be formed of a paramagnetic material (e.g., a steel or other iron-bearing material) such that a tube holder can be secured to the first mount 220 by magnetic attraction from one or more magnets of the tube holder.

The adjustable adapter 200 also includes a second mount 210 that is formed to secure the adjustable adapter 200 to a sort block of a particle sorter (not shown). Note that this is an optional feature of an adjustable adapter as described herein; instead, the adjustable adapter can be part of the particle sorting apparatus and can lack the second mount 210, instead being incorporated into the particle sorter apparatus in some other manner. The second mount 210 includes first 212 and second 214 contact surfaces via which the second mount 210 can contact the sort block of a particle sorter. The adjustable adapter 200 also includes an aperture 216 through which streams of droplets emitted from the sort block can pass to eventually enter sample containers (e.g., sample tubes) that are mounted (e.g., via a multi-tube holder) to the first mount 220.

To facilitate alignment of two or more sample containers that are coupled to the first mount 210 with respective droplet streams being emitted from a sort block (though the aperture 216), the adjustable adapter 200 is adjustable to (i) control an orientation of the first mount 220 relative to the sort block about a first axis 201a that is substantially parallel to an overall direction of the plurality of streams when the second mount 210 is secured to the sort block and the particle sorter is emitting the plurality of streams and (ii) control translation of the first mount 220 relative to the sort block in a first direction 201b that is substantially perpendicular to the first axis 20la. The overall direction of the plurality of streams can be an average direction of all of the streams, a direction of a middle-most stream, or some other representative direction of the streams.

This particular level of control over the location and orientation of the first mount 220 relative to the sort block allows for misalignment between the streams and the corresponding sample containers coupled to the first mount 220 to be easily corrected manually. Additionally, these degrees of freedom of the relative alignment between the streams and the corresponding sample containers are least likely to be correctable by adjusting the operation of the particle sorting apparatus (e.g., due to the particle sorting apparatus being operable only to adjust the absolute or relative angles of the streams within a set, non-adjustable plane relative to the sort block).

Controlling the translation of the first mount 220 in the first direction 201b and rotation of the first mount 220 about the first axis 201a can be accomplished in a variety of ways. For example, the adjustable adapter 200 can include two screws (not shown) disposed within threaded holes 230 through the adjustable adapter 200. Rotation of one or both screws can effect adjustment of the rotation of the adjustable adapter 200 about the first axis 201a and/or translation of the adjustable adapter 200 along the first direction 201b. For example, the screws can protrude from the threaded holes 230 such that the ends of the screws are in contact with the particle sorter (e.g., with a surface of the sort block) when the adjustable adapter 200 is secured, via the second mount 210, to the sort block. Accordingly, in-common rotation of the two screws would result in both screws extending from/retracting toward the threaded holes 230, resulting in the adjustable adapter 200 (and the first mount 220 thereof) translating along the first direction 201b. Conversely, differential rotation of the two screws would result in one screw extending from its threaded hole 230 and the other screw retracting toward its threaded hole 230, resulting in the adjustable adapter 200 (and the first mount 220 thereof) rotating about the first axis 201a.

Note that “in-common” rotation of the two screws means rotations thereof that result in both screws moving similarly out of/into the threaded holes 230; thus, if the screws have the same threading (e.g., left-handed thread), then in-common rotation thereof will also mean rotation in the same direction (e.g., counter-clockwise). If the screws have different threading (i.e., one left-handed and the other right-handed), then in-common rotation thereof will mean rotation in opposite directions (i.e., one clockwise and the other counter-clockwise). Similarly, “differential” rotation of the two screws means rotations thereof that result in one of the screws moving out of its threaded hole 230 and the other moving into its threaded bole 230.

The second mount 210 can be secured to the sort block in a variety of ways, e.g., via bolting to threaded features of the sort block, magnetic clamping, mechanical clamping, or some other securing means. For example, the adjustable adapter 200 can include one or more threaded holes 217 into which respective one or more set screws (not shown) are disposed. The set screw(s) can be adjusted such that, when the second mount 210 is mounted to the sort block with the first contact surface 212 in contact with a corresponding contact surface of the sort block, the set screw(s) engage in friction contact with an additional contact surface of the sort block such that the second mount 210 is secured to the sort block by the friction contact. A magnitude of this friction contact can be adjusted by rotating the set screw(s). Alternatively, the second mount 210 of the adjustable adapter 200 can be insecurely mounted to the sort block and then, once the translation and rotation of the first mount 220 relative to the sort block has been set to align the droplet streams with corresponding sample containers, such set screws can be tightened to secure the second mount 210 to the sort block.

To facilitate alignment of an adjustable adapter as described herein, the adjustable adapter can include a laser and/or laser mount to illuminate the droplet streams near where they enter corresponding sample containers that have been mounted to the adjustable adapter (e.g., via a first mount 220 thereof). To facilitate the use of such a laser to guide the alignment of the particle sorter with a set of sample containers, the adjustable adapter can include a laser mount that allows a laser mounted thereto to be moved vertically, horizontally, and in a horizontal sweep to align with the sorted droplet streams above tubes that can have varying heights.

The ability to move the mount vertically allows the mount to be first adjusted coarsely in the vertical direction to adapt to any changes in the height of sample containers mounted to the adjustable adapter (e.g., due to swapping out one multiple tube holder for another). Once the vertical location of the mount has been adjusted, the horizontal location and angle can be adjusted in order to adapt to any misalignment between the farthest sort streams and the sample collection tubes for a multi-way (e.g., 6-way) sort.

The adjustable adapter 200 of FIGS. 2-6 includes such an adjustable laser mount 240 to which a laser can be mounted (e.g., by being snapped in place in the laser mount 240). The laser mount 240 can be rigidly coupled to a first knob 262 and a laser set screw 260. The screw extends through a slot 247 in a laser mount arm 245 and threads into a laser set nut 264. The laser mount arm 245 is able to move vertically within tracks 252 formed in a body of the adjustable adapter 200 along a second direction 203a that is substantially parallel to the first direction 201b and can be secured using, e.g., a set screw (not shown).

When the laser set screw 260 is loosened from the laser set nut 264, the laser mount 240 is able to translate along a third direction 203b that is substantially perpendicular to the second direction 203b and to rotate about a second axis 203c that is substantially perpendicular to the third direction 203b. Tightening the laser set screw 260 into the laser set nut 264 secures the translation of the laser mount 240 along the third direction 203b and the rotation of the laser mount 240 about the second axis 203c.

Other mechanisms are possible to permit a laser mount to be adjusted according to the three degrees of freedom 203a, 203b, 203c. However, the particular mechanism depicted herein beneficially allows both rotation about the second axis 203c and translation along the third direction 203b to be secured by tightening a single screw 260 into a signal nut 264 by rotating them relative to each other about the second axis 203c. This allows the laser mount 240 to be easily aligned such that a laser beam emitted therefrom passes through all of the sorted droplet streams and then secured in this alignment using a minimum of force and effort.

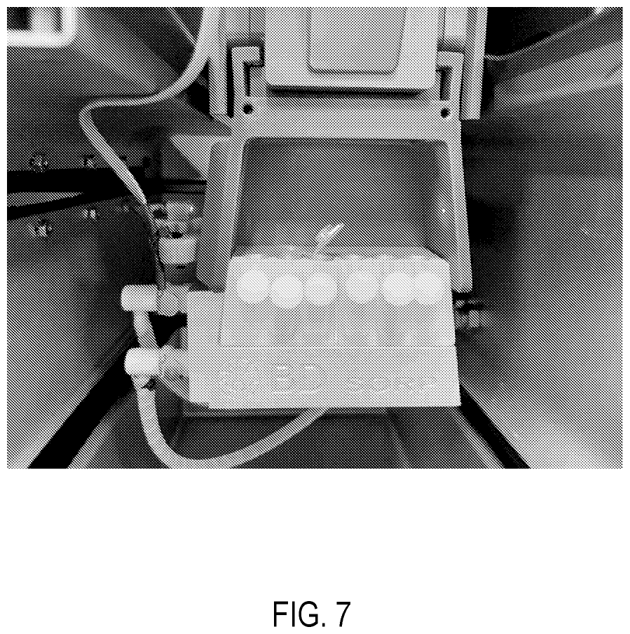

FIG. 7 depicts elements of a particle sorting system, including an adjustable adapter, laser, laser mount, sample containers, and multi-sample container holder as described herein. As shown in FIG. 7, the sample holder holds a single sample container, into which a single droplet stream is being deposited. The single droplet stream is being illuminated by light emitted from a laser mounted in the laser mount. The sample holder is able to contain six sample containers and includes fittings to receive coolant, thereby allowing the sample holder, and sample containers disposed therein, to be refrigerated. The sample holder includes six set screws that can be used to hold sample containers in place and/or to allow sample containers of different diameters to be securely held in the sample holder.

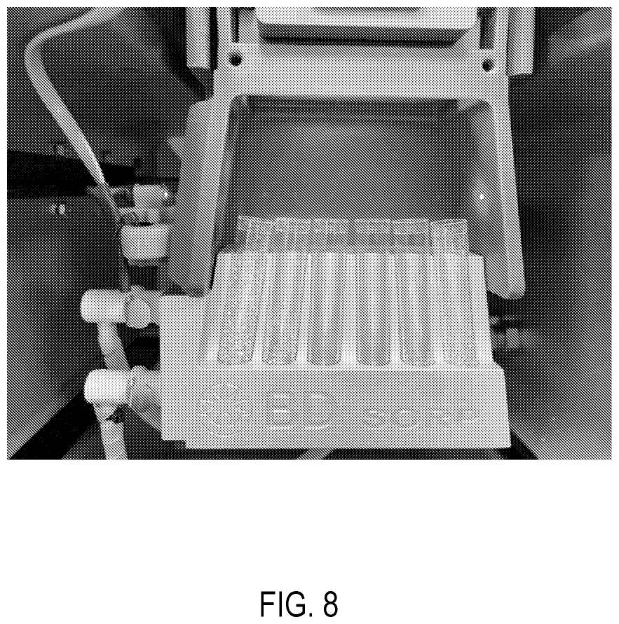

FIG. 8 depicts elements of a particle sorting system, including an adjustable adapter, laser, laser mount, sample containers, and multi-sample container holder as described herein. As shown in FIG. 8, the sample holder holds six sample containers, into which six droplet streams are being deposited. The six droplet streams are all being illuminated by light emitted from a laser mounted in the laser mount. The sample holder includes fittings to receive coolant, thereby allowing the sample holder, and sample containers disposed therein, to be refrigerated.

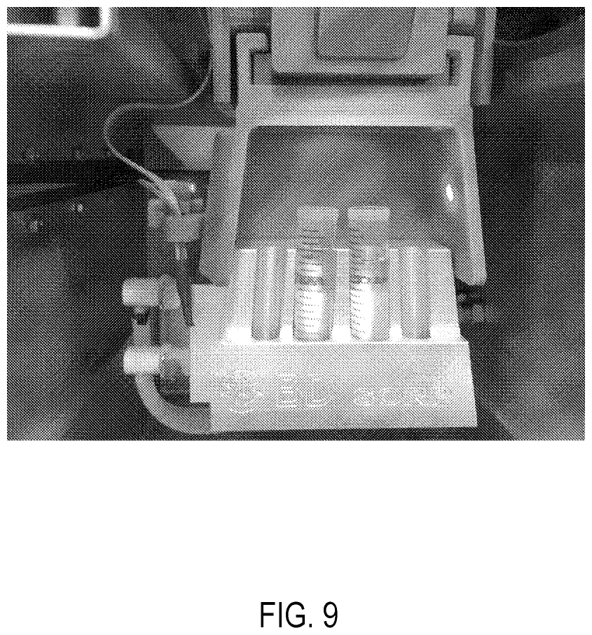

FIG. 9 depicts elements of a particle sorting system, including an adjustable adapter, laser, laser mount, sample containers, and multi-sample container holder as described herein. As shown in FIG. 9, the sample holder holds two sample containers (but is capable of holding four sample containers), into which two droplet streams are being deposited. The two droplet streams are all being illuminated by light emitted from a laser mounted in the laser mount. The sample holder includes fittings to receive coolant, thereby allowing the sample holder, and sample containers disposed therein, to be refrigerated.

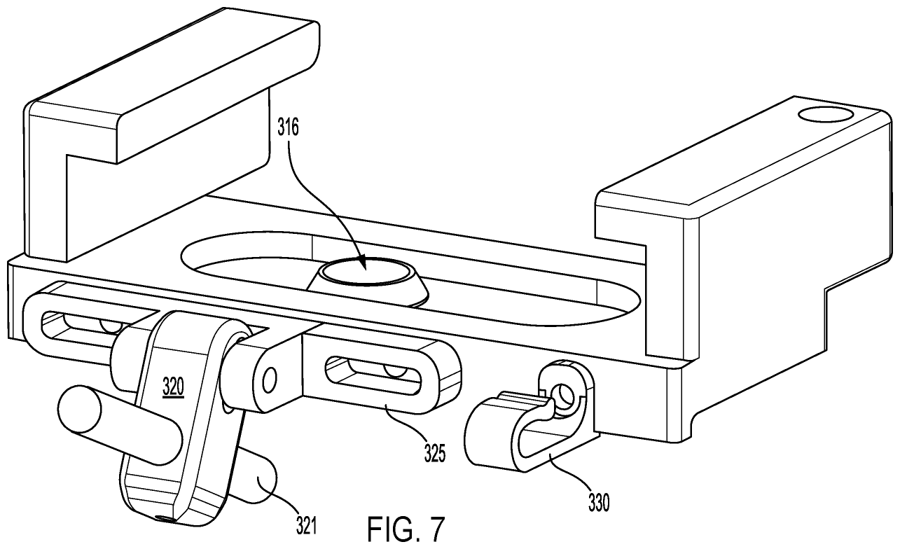

A particle sorting system as described herein can also be used to direct streams of droplets into respective different wells of a multi-well sample plate. However, alignment of such a plate to the sort block can be made challenging due to difficulties in directly observing the droplet streams as they interact with the plate. Also provided herein is a camera adaptor 300 (depicted in FIG. 10) that is mountable to the sort block of a particle sorting system and that includes a camera mount 320 to which a camera 321 can be mounted to facilitate viewing of the sample plate within the particle sorting apparatus. The camera adaptor 300 includes an aperture 316 through which streams of droplets emitted from the sort block can pass. Such an adaptor 300 can include a magnet to activate a switch on the instrument allowing cell deposition into a variety of plate sizes, including custom plate sizes. The most frequently used plates are 96 well plates.

Video generated by the camera 321 can facilitate improved set up and monitoring for correct plate movement. The plate movement can be recorded and used to confirm the proper sorting movements after a plate sort is finished using software already present on the instrument. The camera adaptor 300 includes an adjustment bracket 325 that allows the angle and location of the camera 321 to be adjusted. A clip 330 is also provided to facilitate routing of cabling from the camera 321.

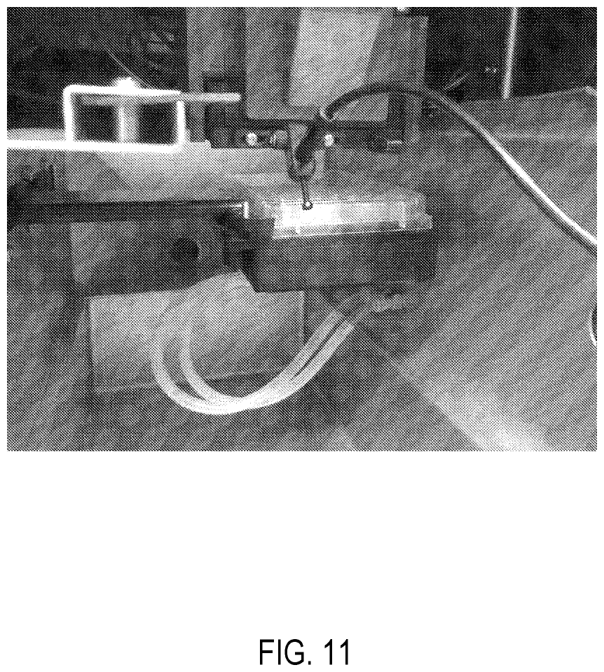

FIG. 11 depicts elements of a particle sorting system, including a camera adapter, and multi-well sample plate as described herein. As shown in FIG. 11, the multi-well sample plate is held by a sample holder that includes fittings to receive coolant, thereby allowing the sample holder, and multi-well sample plate disposed thereon, to be refrigerated. A camera adapter, with camera mounted thereto, is also depicted.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. An adjustable adapter comprising:
a first mount that is formed to secure the adjustable adapter to a sort block of a particle sorter, wherein the particle sorter emits, from the sort block, a plurality of streams of particle-bearing fluid in respective different directions; and
a second mount that is formed to secure a tube holder to the adjustable adapter, wherein the adjustable adapter is adjustable to (i) control an orientation of the second mount relative to the sort block about a first axis that is substantially parallel to an overall direction of the plurality of streams when the first mount is secured to the sort block and the particle sorter is emitting the plurality of streams and (ii) control translation of the second mount relative to the sort block in a first direction that is substantially perpendicular to the first axis.

2. The adjustable adapter of claim 1, further comprising two screws, wherein the two screws are disposed within respective threaded holes through the adjustable adapter such that, when the first mount is secured to the sort block, differential rotation of the two screws results in adjustment of the orientation of the second mount relative to the sort block about a first axis and in-common rotation of the two screws results in adjustment of the translation of the second mount relative to the sort block along the first direction.

3. The adjustable adapter of claim 2, wherein respective ends of the two screws are in contact with the particle sorter when the first mount is secured to the sort block.

4. The adjustable adapter of claim 2, further comprising a set screw, wherein an end of the set screw is in friction contact with the particle sorter when the first mount is secured to the sort block, thereby securing the first mount to the sort block, and wherein a magnitude of the friction contact of the set screw with the particle sorter is adjustable by rotating the set screw.

5. The adjustable adapter of claim 1, further comprising a laser mount, wherein the laser mount is operable to direct a laser mounted thereto through the plurality of streams of particle-bearing fluid when the first mount is secured to the sort block.

6. The adjustable adapter of claim 5, wherein the laser mount is adjustable to (i) control translation of a laser mounted thereto relative to the second mount along a second direction that is substantially parallel to the first direction, (ii) control translation of a laser mounted thereto relative to the second mount along a third direction that is substantially perpendicular to the second direction, and (iii) control an orientation of a laser mounted thereto relative to the second mount about a second axis that is substantially perpendicular to the third direction.

7. The adjustable adapter of claim 6, further comprising a laser set screw and a laser set nut, wherein the laser set screw is threaded into the laser set nut, and wherein the laser set screw is disposed within a slot in a laser mount arm that extends along the third direction such that tightening the laser set screw into the laser set nut secures the translation of a laser mounted to the laser mount along the third direction and secures the orientation of a laser mounted to the laser mount about the second axis and further such that loosening the laser set screw from the laser set nut permits adjustment of the translation of a laser mounted to the laser mount along the third direction and the orientation of a laser mounted to the laser mount about the second axis, and wherein the laser mount is rigidly coupled to one of the laser set screw or the laser set nut such that rotation of the one of the laser set screw or the laser set nut about the second axis results in the rotation of the laser mount about the second axis.

8. The adjustable adapter of claim 5, further comprising two screws, wherein the two screws are disposed within respective threaded holes through the adjustable adapter such that, when the first mount is secured to the sort block, differential rotation of the two screws results in adjustment of the orientation of the second mount relative to the sort block about a first axis and in-common rotation of the two screws results in adjustment of the translation of the second mount relative to the sort block along the first direction.

9. The adjustable adapter of claim 8, wherein the laser mount is adjustable to (i) control translation of a laser mounted thereto relative to the second mount along a second direction that is substantially parallel to the first direction, (ii) control translation of a laser mounted thereto relative to the second mount along a third direction that is substantially perpendicular to the second direction, and (iii) control an orientation of a laser mounted thereto relative to the second mount about a second axis that is substantially perpendicular to the third direction.

10. The adjustable adapter of claim 9, further comprising a laser set screw and a laser set nut, wherein the laser set screw is threaded into the laser set nut, and wherein the laser set screw is disposed within a slot in a laser mount arm that extends along the third direction such that tightening the laser set screw into the laser set nut secures the translation of a laser mounted to the laser mount along the third direction and secures the orientation of a laser mounted to the laser mount about the second axis and further such that loosening the laser set screw from the laser set nut permits adjustment of the translation of a laser mounted to the laser mount along the third direction and the orientation of a laser mounted to the laser mount about the second axis, and wherein the laser mount is rigidly coupled to one of the laser set screw or the laser set nut such that rotation of the one of the laser set screw or the laser set nut about the second axis results in the rotation of the laser mount about the second axis.

11. A system comprising:
a particle sorter configured to emit, from a sort block, a plurality of streams of particle-bearing fluid in respective different directions; and
an adjustable adapter comprising:
a first mount that is formed to secure a tube holder to the adjustable adapter, wherein the adjustable adapter is adjustable to (i) control an orientation of the first mount relative to the sort block about a first axis that is substantially parallel to an overall direction of the plurality of streams when the particle sorter is emitting the plurality of streams and (ii) control translation of the first mount relative to the sort block in a first direction that is substantially perpendicular to the first axis.

12. The system of claim 11, wherein the adjustable adapter further comprises:
a second mount that is formed to secure the adjustable adapter to the sort block; and
two screws, wherein the two screws are disposed within respective threaded holes through the adjustable adapter such that, when the second mount is secured to the sort block, differential rotation of the two screws results in adjustment of the orientation of the first mount relative to the sort block about a first axis and in-common rotation of the two screws results in adjustment of the translation of the first mount relative to the sort block along the first direction.

13. The system of claim 12, wherein respective ends of the two screws are in contact with the particle sorter when the second mount is secured to the sort block.

14. The system of claim 12, wherein the adjustable adapter further comprises a set screw, wherein an end of the set screw is in friction contact with the particle sorter when the second mount is secured to the sort block, thereby securing the second mount to the sort block, and wherein a magnitude of the friction contact of the set screw with the particle sorter is adjustable by rotating the set screw.

15. The system of claim 11, wherein the adjustable adapter further comprises a laser mount, wherein the laser mount is operable to direct a laser mounted thereto through the plurality of streams of particle-bearing fluid.

16. The system of claim 15, wherein the laser mount is adjustable to (i) control translation of a laser mounted thereto relative to the first mount along a second direction that is substantially parallel to the first direction, (ii) control translation of a laser mounted thereto relative to the first mount along a third direction that is substantially perpendicular to the second direction, and (iii) control an orientation of a laser mounted thereto relative to the first mount about a second axis that is substantially perpendicular to the third direction.

17. The system of claim 16, wherein the adjustable adapter further comprises a laser set screw and a laser set nut, wherein the laser set screw is threaded into the laser set nut, and wherein the laser set screw is disposed within a slot in a laser mount arm that extends along the third direction such that tightening the laser set screw into the laser set nut secures the translation of a laser mounted to the laser mount along the third direction and secures the orientation of a laser mounted to the laser mount about the second axis and further such that loosening the laser set screw from the laser set nut permits adjustment of the translation of a laser mounted to the laser mount along the third direction and the orientation of a laser mounted to the laser mount about the second axis, and wherein the laser mount is rigidly coupled to one of the laser set screw or the laser set nut such that rotation of the one of the laser set screw or the laser set nut about the second axis results in the rotation of the laser mount about the second axis.

18. The system of claim 15, wherein the adjustable adapter further comprises two screws, wherein the two screws are disposed within respective threaded holes through the adjustable adapter such that differential rotation of the two screws results in adjustment of the orientation of the first mount relative to the sort block about a first axis and in-common rotation of the two screws results in adjustment of the translation of the first mount relative to the sort block along the first direction.

19. The system of claim 18, wherein the laser mount is adjustable to (i) control translation of a laser mounted thereto relative to the first mount along a second direction that is substantially parallel to the first direction, (ii) control translation of a laser mounted thereto relative to the first mount along a third direction that is substantially perpendicular to the second direction, and (iii) control an orientation of a laser mounted thereto relative to the first mount about a second axis that is substantially perpendicular to the third direction.

20. The system of claim 19, wherein the adjustable adapter further comprises a laser set screw and a laser set nut, wherein the laser set screw is threaded into the laser set nut, and wherein the laser set screw is disposed within a slot in a laser mount arm that extends along the third direction such that tightening the laser set screw into the laser set nut secures the translation of a laser mounted to the laser mount along the third direction and secures the orientation of a laser mounted to the laser mount about the second axis and further such that loosening the laser set screw from the laser set nut permits adjustment of the translation of a laser mounted to the laser mount along the third direction and the orientation of a laser mounted to the laser mount about the second axis, and wherein the laser mount is rigidly coupled to one of the laser set screw or the laser set nut such that rotation of the one of the laser set screw or the laser set nut about the second axis results in the rotation of the laser mount about the second axis.
